(19) United States
(12) Patent Application Publication
(10) Pub. No.: US 2026/0230509 A1
(43) Pub. Date: Aug. 6, 2026

(54) EXTENDED REALITY AND MULTIMEDIA SERVICE DATA TRANSMISSION METHOD AND APPARATUS, AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Yuxin MAO, Beijing (CN)

(21) Appl. No.: 19/148,389

(22) PCT Filed: Jan. 16, 2023
(86) PCT No.: PCT/CN2023/072475

§ 371 Date: Jul. 16, 2025

(51) Int. Cl. H04L 65/1069; H04L 12/14; H04L 65/80

(52) U.S. Cl. CPC H04L 65/1069; H04L 12/1407; H04L 65/80

(57) ABSTRACT

A method for extended reality and multimedia (XRM) services data transmission is applied in a core network device. The method includes: determining an application function (AF) session request, wherein the AF session request includes group information of a service data flow (SDF) group; and performing a policy decision on the AF session request based on the group information.

### CROSS REFERENCE

The present application is a national phase application of International Application No. PCT/CN2023/072475, filed on Jan. 16, 2023, and the entire contents thereof are incorporated herein by reference.

### TECHNICAL FIELD

The present disclosure relates to the field of communication technology, and more particularly to an extended reality and multimedia (Extend Reality and Media, XRM) service data transmission method, apparatus and storage medium.

### BACKGROUND

Mobile media services, cloud augmented reality (AR)/virtual reality (VR) and other extended reality (XR), cloud games, video-based machine or drone remote control and other services will contribute more and more traffic to 5G networks. The Extend Reality and Media (XRM) services (also called multimodal services) involve multimodal data. The service data flows in multimodal data often have strong correlations, such as the need for synchronization of audio flows and video flows, and the need for synchronization of touch and vision. There are some common characteristics in the data flows of such media services, between the data flows, and the network transmission requirements of these service data flows. The effective identification and use of these characteristics will help the transmission and control of the network and services, as well as service assurance and user experience.

In the related art, the XRM services need to comprehensively consider the Quality of Service (QoS) characteristics of the service data flows related to the services, and the QoS authorization between multiple service data flows of a single terminal or data flows of multiple terminals needs to be consistent.

### SUMMARY

The present disclosure provides an extended reality and multimedia service data transmission method, apparatus and storage medium.

According to a first aspect of an embodiment of the present disclosure, a method, apparatus, and storage medium method for transmitting extended reality and multimedia service data are provided, which are applied to a core network device. The method includes:
determining an application function (AF) session request, where the AF session request includes group information of a service data flow (SDF) group; and
performing a policy decision on the AF session request based on the group information.

According to a second aspect of an embodiment of the present disclosure, a method, apparatus and storage medium for transmitting extended reality and multimedia service data are provided, which are performed by a policy control function (PCF) entity in a core network device, and the method includes: receiving an application function (AF) session request, where the AF session request includes group information of a service data flow (SDF) group; and
performing a policy decision on the AF session request based on the group information.

According to a third aspect of an embodiment of the present disclosure, a method, apparatus and storage medium method for transmitting extended reality and multimedia service data are provided, which are performed by an application function (AF) entity. The method includes: sending an application function (AF) session request, where the AF session request includes group information of a service data flow (SDF) group, and the AF session request is used by a policy control function (PCF) entity to perform a policy decision on the AF session request.

According to a fourth aspect of the embodiments of the present disclosure, a method, apparatus and storage medium for transmitting extended reality and multimedia service data are provided, which are performed by a core network element function in a core network device, and the method includes: receiving an application function (AF) session request, where the AF session request includes group information of a service data flow (SDF) group, and the AF session request is used for a policy control function (PCF) entity to perform a policy decision on the AF session request; and
sending the AF session request to the policy control function (PCF) entity.

According to a fifth aspect of the embodiments of the present disclosure, a method, apparatus and storage medium for transmitting extended reality and multimedia service data are provided, including: an application function (AF) entity sending an AF session request, where the AF session request includes group information of a service data flow (SDF) group; and
a policy control function (PCF) entity receiving the AF session request and performs a policy decision on the AF session request based on the group information.

According to a sixth aspect of an embodiment of the present disclosure, there is provided an apparatus for extended reality and multimedia service data transmission, including: a determination module, configured to determine an application function (AF) session request, where the AF session request includes group information of a service data flow (SDF) group; and
a performing module, configured to perform a policy decision on the AF session request based on the group information.

According to a seventh aspect of an embodiment of the present disclosure, there is provided an apparatus for extended reality and multimedia service data transmission, which is applied to a policy control function (PCF) entity, and the apparatus includes: a receiving module, configured to receive an application function (AF) session request, where the AF session request includes group information of a service data flow (SDF) group; and
a performing module, configured to perform a policy decision on the AF session request based on the group information.

According to an eighth aspect of an embodiment of the present disclosure, an apparatus for transmitting extended reality and multimedia service data is provided, the apparatus includes: a sending module, configured to an application function (AF) session request, the AF session request including group information of a service data flow (SDF) group, the AF session request being used by a policy control function (PCF) entity to perform a policy decision on the AF session request.

According to a ninth aspect of an embodiment of the present disclosure, there is provided an apparatus for extended reality and multimedia service data transmission, the apparatus includes: a receiving module, configured to receive an application function (AF) session request, the AF session request including group information of a service data flow (SDF) group, the AF session request being used by a policy control function (PCF) entity to perform a policy decision on the AF session request; and
a sending module, configured to send the AF session request to the policy control function (PCF) entity.

According to a tenth aspect of an embodiment of the present disclosure, an apparatus for extended reality and multimedia service data transmission is provided, the apparatus includes:
a sending module, an application function (AF) entity sends an AF session request, where the AF session request includes group information of a service data flow (SDF) group;
a receiving module, configured for a policy control function (PCF) entity to receive the AF session request; and
a performing module, configured for the PCF entity to perform a policy decision on the AF session request based on the group information.

According to an eleventh aspect of an embodiment of the present disclosure, there is provided an extended reality and multimedia service data transmission apparatus, including a processor; a memory for storing processor executable instructions; where the processor is configured to: execute the method described in the above-mentioned first aspect or second aspect or third aspect or fourth aspect and any one of the embodiments thereof.

According to the twelfth aspect of an embodiment of the present disclosure, a storage medium is provided, in which instructions are stored. When the instructions in the storage medium are executed by a processor of a core network device, the core network device is enabled to execute the method described in the first aspect, or when the instructions in the storage medium are executed by a processor of a policy control function (PCF) entity, the PCF entity is enabled to execute the method described in the second aspect, or when the instructions in the storage medium are executed by a processor of an application function (AF) entity, the AF entity is enabled to execute the method described in the third aspect, or when the instructions in the storage medium are executed by a processor of a core network function network element, the core network function network element is enabled to execute the method described in the fourth aspect, or when the instructions in the storage medium are executed by a processor of a PCF entity or an AF entity in a core network device, the PCF entity or the AF entity is enabled to execute the method described in the fifth aspect.

According to a thirteenth aspect of an embodiment of the present disclosure, a communication system is provided, where the system is used to execute the method described in the first aspect.

According to a fourteenth aspect of an embodiment of the present disclosure, a communication system is provided, including the following entities:
a PCF entity configured to execute the method described in the second aspect;
an AF entity configured to execute the method described in the second aspect; and
a core network functional network element configured to execute the method described in any one of the fourth aspects.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of a communication system according to an exemplary embodiment.

FIG. 2 is a flow chart showing a method for extended reality and multimedia service data transmission according to an exemplary embodiment.

FIG. 3 is a flow chart showing a method for extended reality and multimedia service data transmission according to an exemplary embodiment.

FIG. 4 is a flow chart showing a method for extended reality and multimedia service data transmission according to an exemplary embodiment.

FIG. 5 is a flow chart showing a method for extended reality and multimedia service data transmission according to an exemplary embodiment.

FIG. 6 is a flow chart showing a method for extended reality and multimedia service data transmission according to an exemplary embodiment.

FIG. 7 is a flow chart showing a method for extended reality and multimedia service data transmission according to an exemplary embodiment.

FIG. 8 is a flow chart showing a method for extended reality and multimedia service data transmission according to an exemplary embodiment.

FIG. 9 is a flow chart showing a method for extended reality and multimedia service data transmission according to an exemplary embodiment.

FIG. 10 is a flow chart showing a method for extended reality and multimedia service data transmission according to an exemplary embodiment.

FIG. 11 is a flow chart showing a method for extended reality and multimedia service data transmission according to an exemplary embodiment.

FIG. 12 is a block diagram showing an apparatus for extended reality and multimedia service data transmission according to an exemplary embodiment.

FIG. 13 is a block diagram showing an apparatus for extended reality and multimedia service data transmission according to an exemplary embodiment.

FIG. 14 is a block diagram showing an apparatus for extended reality and multimedia service data transmission according to an exemplary embodiment.

FIG. 15 is a block diagram showing an apparatus for extended reality and multimedia service data transmission according to an exemplary embodiment.

FIG. 16 is a block diagram showing an apparatus for extended reality and multimedia service data transmission according to an exemplary embodiment.

FIG. 17 is a block diagram showing an apparatus for transmitting data of extended reality and multimedia services according to an exemplary embodiment.

### DETAILED DESCRIPTION

Exemplary embodiments are described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the present disclosure.

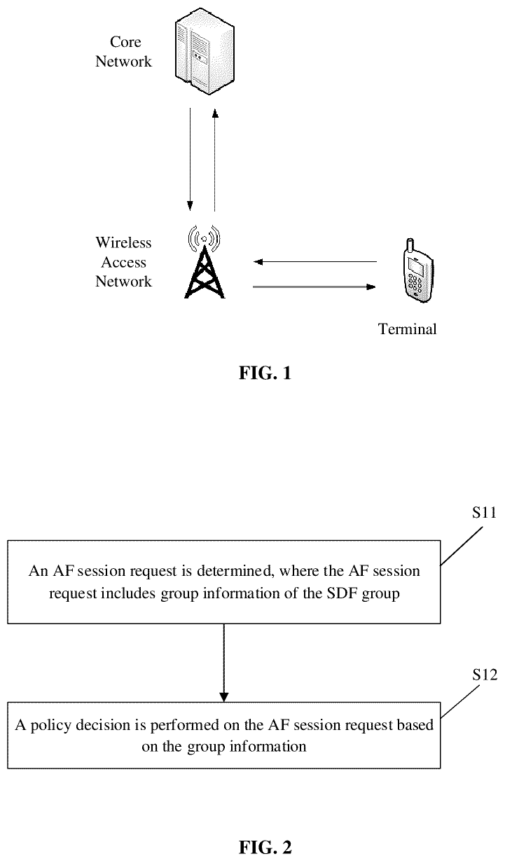

The extended reality and multimedia service data transmission method provided by the embodiment of the present disclosure can be applied to the wireless communication system shown in FIG. 1. As shown in FIG. 1, the mobile station accesses the wireless access network through a wireless access network device such as a base station, and the wireless access network device and the core network device complete the backhaul and forward transmission of data to perform various communication services.

It can be understood that a wireless communication system is a network that provides wireless communication functions. The wireless communication system can use different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), carrier sense multiple access/collision avoidance (Carrier Sense Multiple Access with Collision Avoidance). According to the capacity, rate, delay and other factors of different networks, the network can be divided into 2G (generation) network, 3G network, 4G network or future evolution network, such as 5G network, 5G network can also be called new radio network (New Radio, NR). For the convenience of description, the present disclosure sometimes refers to the wireless communication network as a network or system. In the present disclosure, the network may include a radio access network (RAN) and a core network (CN). The network includes network equipment, which may be a radio access network node, a core network function, etc. The radio access network node may also be referred to as a base station. The network may provide network services to the terminal through the network equipment, and different operators may provide different network services to the terminal, which may also be understood as different operators corresponding to different operator networks.

Mobile Station (MS), also known as User Equipment (UE), Terminal, Mobile Terminal (MT), etc., is a device that provides voice and/or data connectivity to users. For example, the terminal can be a handheld device with wireless connection function, a vehicle-mounted device, etc. At present, some examples of terminals are: smart phones (Mobile Phones), pocket personal computers (PPC), handheld computers, personal digital assistants (PDA), laptops, tablet computers, wearable devices, or vehicle-mounted devices, etc.

The 5G system includes devices for managing and coordinating access and mobility-related requirements of the wireless access network and terminals. For example, the core network functions include session management function equipment (SMF), access and mobility management function (AMF), radio access network (RAN), unified data management equipment (UDM), policy control function equipment (PCF), user plane function equipment (UPF), and user equipment (UE). Of course, the core network functions also include other types of equipment, which are not listed one by one in the embodiments of the present disclosure.

The following is a detailed introduction to the relevant entity functions involved in the embodiments of the present disclosure.

The AF entity is responsible for interacting with the 3GPP core network to provide service or services, including interaction with NEF, interaction with policy architecture, etc.

The main functions of the NEF entity include: securely opening up the services and capabilities provided by 3GPP network functions, including internal opening or opening up to third parties, etc. Transform or translate the information interacting with AF and the information interacting with internal network functions, such as AF service identifier and internal 5G core network information such as Data Network Name (DNN), Single Network Slice Selection Assistance Information (S-NSSAI), etc.

The AMF entity is responsible for access and mobility management. Its main functions include: connection management, mobility management, registration management, access authentication and authorization, reachability management, security context management, user authentication, handover, location update and other access and mobility related functions.

The main functions of the PCF entity include unified policy formulation, provision of policy control, and policy-related function such as obtaining subscription information related to policy decisions from the unified data management (UDR) database.

The UPF entity is responsible for user plane functions, including: data packet routing and transmission, packet detection, service usage reporting, QoS processing, legal monitoring, uplink packet detection, downlink packet storage and other user plane related functions.

The SMF entity is responsible for session management functions. Its main functions include: session management (such as session establishment, modification and release, including tunnel maintenance between UPF and AN), UPF selection and control, service and session continuity (service and session continuity, SSC) mode selection, roaming and other session-related functions.

Mobile media services, cloud augmented reality (AR)/virtual reality (VR) and other extended range (XR), cloud games, video-based machine or drone remote control and other services will contribute more and more traffic to 5G networks. The extended reality and multimedia (XRM) services (also called multimodal services) involve multimodal data. The data flows of each service in multimodal data often have a strong correlation, such as the need for synchronization of audio flows and video flows, and the need for synchronization of touch and vision. There are some common characteristics in the data flows of this type of media services, between the data flows, and the network transmission requirements of these service data flows. The effective identification and use of these characteristics will help the transmission and control of the network and services, as well as service assurance and user experience.

In related technologies, XRM services need to comprehensively consider the Quality of Service (QoS) characteristics of the service data flows related to the services, and the QoS authorization between multiple service data flows of a single terminal or data flows of multiple terminals needs to be consistent.

However, the current Policy Control Function (PCF) cannot determine the scope and scale of the XMR service group, cannot accurately determine the QoS authorization requirements of the XRM service group, and cannot accurately perform QoS authorization for multiple service data flows (Service Data Flow, SDF) within the XRM group.

Based on this, an embodiment of the present disclosure provides an XRM service data transmission method, where PCF receives an AF session request. Since the AF session request includes group information of the SDF group, PCF can determine which SDFs are in one group based on the group information of the SDF group, thereby performing more reasonable policy decisions and resource authorization for each SDF in the SDF group, and providing better QoS guarantee for the transmission of the SDF.

FIG. 2 is a flow chart of an XRM service data transmission method according to an exemplary embodiment. As shown in FIG. 2, the method is applied to a core network device and includes the following steps.

In step S11, an AF session request is determined, where the AF session request includes group information of the SDF group.

In the embodiment, the group information of the SDF group is used to indicate the attribute information of the SDFs belonging to the same group, such as the number of SDFs belonging to the same group, SDF flow description information, the number of corresponding terminals, etc.

In one implementation, the multiple SDFs indicated by the group information of the SDF group are from the same terminal or from different terminals (i.e., a terminal group).

In step S12, a policy decision is performed on the AF session request based on the group information.

In the embodiment of the present disclosure, the core network device determines an AF session request. Since the AF session request includes group information of the SDF group, the core network device can determine which SDFs are in one group based on the group information of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, the group information includes at least one of:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the group information includes the number of SDFs included in the SDF group. When the core network device receives the AF session request, the core network device determines the number of SDFs included in the SDF group based on the group information and executes a policy decision for the SDFs corresponding to the number of SDFs.

In one implementation, the group information includes all SDF flow description information included in the SDF group. When the core network device receives the AF session request, the core network device determines all SDF flow description information included in the SDF group based on the group information, and after receiving the SDF corresponding to the corresponding SDF flow description information, the core network device performs a policy decision on the SDF.

In one implementation, the group information includes all SDF flow description information contained in the SDF group and the association relationship/priority relationship between respective SDFs.

When the core network device receives the AF session request, the core network device determines all SDF flow description information contained in the SDF group and the association relationship/priority relationship between respective SDFs based on the group information. The core network device can perform policy decisions for SDFs with stronger associations, or the core network device can prioritize the performing of policy decisions for SDFs with higher priorities.

In one implementation, the group information includes the number of terminals included in the SDF group and the number of SDFs corresponding to each terminal. When the core network device receives the AF session request, the core network device determines the number of terminals included in the SDF group and the number of SDFs corresponding to each terminal based on the group information, so that the core network device can determine whether the SDFs in the SDF group belong to the same terminal or multiple terminals, and make policy decisions.

In one implementation, the group information includes the number of terminals included in the SDF group and the SDF flow description information corresponding to each terminal. When the core network device receives the AF session request, the core network device determines the number of terminals included in the SDF group and the SDF flow description information corresponding to each terminal based on the group information, so that the core network device can determine whether the SDFs in the SDF group belong to the same terminal or multiple terminals and the SDF flow description information of each terminal, and make policy decisions.

In one implementation, the group information includes the number of terminals included in the SDF group, the SDF flow description information corresponding to each terminal, and the dependency relationship/priority relationship between respective SDFs. When the core network device receives the AF session request, the core network device determines the number of terminals included in the SDF group and the dependency relationship/priority relationship between respective SDFs in the SDF group based on the group information, so that the core network device can perform policy decisions for SDFs with stronger associations, or can prioritize the performing of policy decisions for SDFs with higher priorities.

In the disclosed embodiment, the core network device can determine through group information which SDFs belong to the same group, which UE the SDF corresponds to, and which SDFs of multiple UEs belong to the same group, thereby performing more reasonable policy decisions and resource authorizations for each SDF in the SDF group of the XRM service, and providing better QoS guarantee for the transmission of the SDF.

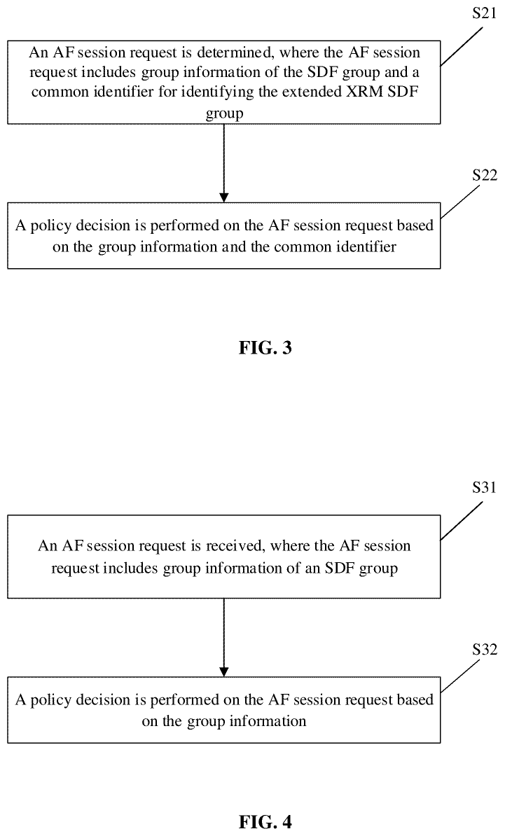

In the XRM service data transmission method provided by an embodiment of the present disclosure, the AF session request also includes a common identifier for identifying an SDF group. When the SDFs indicated in the request information do not all belong to the same group, the group corresponding to each SDF is determined based on the common identifier of each SDF, and a policy decision is performed on the corresponding AF session request. Based on this, an embodiment of the present disclosure also provides an XRM service data transmission method, as shown in FIG. 3, comprising the following steps:

In step S21, an AF session request is determined, where the AF session request includes group information of the SDF group and a common identifier for identifying the extended XRM SDF group.

In step S22, a policy decision is performed on the AF session request based on the group information and the common identifier.

In one implementation, the SDF group information of the AF request indicates 10 SDFs, but the 10 SDFs do not belong to the same group. When receiving the AF session request corresponding to the 10 SDFs, the SDF group to which they belong is determined based on their respective common identifiers.

In the embodiment, multiple SDFs with a common identifier may correspond to the same terminal or multiple terminals.

In the embodiment of the present disclosure, the core network device determines an AF session request. Since the AF session request includes the group information of the SDF group and the session identifier, the core network device can determine which SDFs are in one group based on the group information of the SDF group and the session identifier, thereby performing more reasonable policy decisions and resource authorizations for each SDF in the SDF group, and providing better QoS guarantee for the transmission of the SDF.

In the XRM service data transmission method provided in an embodiment of the present disclosure, performing the policy decision on the AF session request includes:
the core network device authorizes the same QoS to each SDF in the SDF group; or
the core network equipment generates a respective policy control and charging (PCC) rule for each SDF in the SDF group and authorizes respective QoS for each SDF.

In the embodiment, the PCC rules represent the service quality requirements and service billing requirements of the service. The network will provide different QoS services to users according to the service type and subscription level of the user, and report the billing information such as traffic and duration to the billing center for billing by detecting different service data flows.

In the embodiment of the present disclosure, after determining the SDF group to which the SDF belongs, policy decisions can be made for the SDFs in the same group, such as authorizing the same QoS or authorizing respective QoS for each SDF, etc., so that the core network equipment can make more reasonable policy decisions and authorize resources for the XRM service, providing better QoS guarantee for the transmission of the SDF.

In the XRM service data transmission method provided in an embodiment of the present disclosure, a core network device may perform an XRM service data transmission method provided in an embodiment of the present disclosure in the following process:
(a) Setting up an AF session with required QoS procedure;
(b) AF session with required QoS update procedure;
(c) Service specific parameter provisioning process; and
(d) Set a policy for a future AF session.

Hereinafter, the XRM service data transmission method provided by the embodiment of the present disclosure is described by taking the PCF entity in the core network device as the execution subject.

FIG. 4 is a flow chart of a method for XRM service data transmission according to an exemplary embodiment. As shown in FIG. 4, the method is executed by a PCF entity in a core network device and includes the following steps.

In step S31, an AF session request is received, where the AF session request includes group information of an SDF group.

In the embodiment, the SDF group is used to indicate the attribute information of the SDFs belonging to the same group, such as the number of SDFs belonging to the same group, SDF flow description information, the number of corresponding terminals, etc.

In one implementation, the multiple SDFs indicated by the group information of the SDF group are from the same terminal or from different terminals (i.e., a terminal group).

In step S32, a policy decision is performed on the AF session request based on the group information.

In the embodiment of the present disclosure, the PCF receives an AF session request. Since the AF session request includes group information of the SDF group, the PCF can determine which SDFs form one group based on the group information of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the group information includes the number of SDFs included in the SDF group. When the PCF receives the AF session request, the PCF determines the number of SDFs included in the SDF group based on the group information and performs policy decisions for the SDFs corresponding to the number of SDFs.

In one implementation, the group information includes all SDF flow description information included in the SDF group. When the PCF receives the AF session request, the PCF determines all SDF flow description information included in the SDF group based on the group information, and after receiving the SDF corresponding to the corresponding SDF flow description information, the PCF performs a policy decision on the SDF.

In one implementation, the group information includes all SDF flow description information contained in the SDF group and the association relationship/priority relationship between respective SDFs.

When the PCF receives the AF session request, the PCF determines all SDF flow description information contained in the SDF group and the association relationship/priority relationship between respective SDFs based on the group information. The PCF can perform policy decisions for SDFs with stronger associations, or the PCF can prioritize the performing of policy decisions for SDFs with higher priorities.

In one implementation, the group information includes the number of terminals included in the SDF group and the number of SDFs corresponding to each terminal. When the PCF receives the AF session request, the PCF determines the number of terminals included in the SDF group and the number of SDFs corresponding to each terminal based on the group information, so that the PCF can determine whether the SDFs in the SDF group belong to the same terminal or multiple terminals, and make policy decisions.

In one implementation, the group information includes the number of terminals included in the SDF group and the SDF flow description information corresponding to each terminal. When the PCF receives the AF session request, the PCF determines the number of terminals included in the SDF group and the SDF flow description information corresponding to each terminal based on the group information, so that the PCF can determine whether the SDF in the SDF group belongs to the same terminal or multiple terminals and the SDF flow description information of each terminal, and make policy decisions.

In one implementation, the group information includes the number of terminals included in the SDF group, the SDF flow description information corresponding to each terminal, and the dependency relationship/priority relationship between respective SDFs. When the PCF receives the AF session request, the PCF determines the number of terminals included in the SDF group and the dependency relationship/priority relationship between respective SDFs in the SDF group based on the group information, so that the PCF can perform policy decisions for SDFs with stronger associations, or can preferentially perform policy decisions for SDFs with higher priorities.

In the disclosed embodiment, the PCF can determine through group information which SDFs belong to the same group, which UE the SDF corresponds to, and which SDFs of multiple UEs belong to the same group, thereby performing more reasonable policy decisions and resource authorizations for each SDF in the SDF group of the XRM service, and providing better QoS guarantee for the transmission of the SDF.

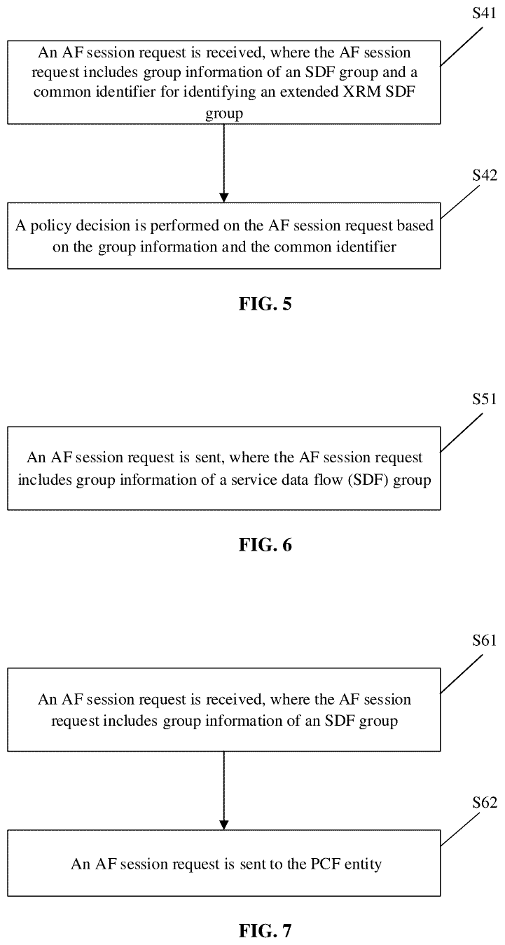

In the XRM service data transmission method provided by an embodiment of the present disclosure, the AF session request also includes a common identifier for identifying an SDF group. When the SDFs indicated in the request information do not all belong to the same group, the group corresponding to each SDF is determined based on the common identifier of each SDF, and a policy decision is performed on the corresponding AF session request. Based on this, an embodiment of the present disclosure also provides an XRM service data transmission method, as shown in FIG. 5, comprising the following steps:

In step S41, an AF session request is received, where the AF session request includes group information of an SDF group and a common identifier for identifying an extended XRM SDF group.

In step S42, a policy decision is performed on the AF session request based on the group information and the common identifier.

In one implementation, the SDF group information requested by the AF indicates 10 SDFs, while the 10 SDFs do not belong to the same group. When receiving the AF session request corresponding to the 10 SDFs, the SDF group to which they belong is determined based on their respective common identifiers.

In the embodiment, multiple SDFs with a common identifier may correspond to the same terminal or multiple terminals.

In the embodiment of the present disclosure, the PCF receives an AF session request. Since the AF session request includes the group information and session identifier of the SDF group, PCF can determine which SDFs are in one group based on the group information and session identifier of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, performing the policy decision on the AF session request includes:
authorizing the same QoS to each SDF in the SDF group; or
generating a respective Policy Control and Charging (PCC) rule for each SDF in the SDF group, and authorizing respective QoS to each SDF with.

In the embodiment, the PCC rules represent the service quality requirements and service billing requirements of the service. The network will provide different QoS services to users according to the service type and the user's subscription level, and report the billing information such as traffic and duration to the billing center for billing by detecting different service data flows.

In the embodiment of the present disclosure, after determining the SDF group to which the SDF belongs, policy decisions can be made for the SDFs in the same group, such as authorizing the same QoS or authorizing respective QoS to each SDF, so that the PCF can make more reasonable policy decisions and authorize resources for the XRM service, providing better QoS guarantee for the transmission of the SDF.

In the XRM service data transmission method provided by an embodiment of the present disclosure, a PCF may receive an AF session request sent by an AF entity, or at least one functional entity of a NEF entity, and a Time Sensitive Communication and Time Synchronization function (TSCTSF) entity.

In the embodiment, when the AF is a trusted AF, the AF entity can directly send the AF session request to the PCF entity. When the AF entity is an untrusted AF entity, the AF entity sends the AF session request to the PCF through the NEF entity and/or the TSCTSF entity.

In the XRM service data transmission method provided in an embodiment of the present disclosure, the PCF may receive an AF session request in the following process:
(a) Setting up an AF session with required QoS procedure;
(b) AF session with required QoS update procedure
(c) Service specific parameter provisioning process; and
(d) Set a policy for a future AF session.

Based on the same concept, an embodiment of the present disclosure also provides an XRM service data transmission method.

FIG. 6 is a flowchart of a method for transmitting XRM service data according to an exemplary embodiment. As shown in FIG. 6, the XRM service data transmission is performed by an AF entity and includes the following steps.

In step S51, an AF session request is sent, where the AF session request includes group information of a service data flow (SDF) group.

In the embodiment, the group information of the SDF group is used to indicate the attribute information of the SDFs belonging to the same group, such as the number of SDFs belonging to the same group, the SDF flow description information, the number of corresponding terminals, etc.

In one implementation, the multiple SDFs indicated by the group information of the SDF group are from the same terminal or from different terminals (i.e., a terminal group).

In one implementation, the AF session request is used by the PCF entity to perform a policy decision on the AF session request.

In the embodiment of the present disclosure, the AF sends an AF session request. Since the AF session request includes group information of the SDF group, the PCF can determine the group information of the SDF group and determine which SDFs form one group, such that the PCF performs more reasonable policy decisions and resource authorizations for each SDF in the SDF group, and providing better QoS guarantee for the transmission of the SDF.

In the XRM service data transmission method provided in an embodiment of the present disclosure, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the group information includes the number of SDFs included in the SDF group. When the PCF receives the AF session request, the PCF determines the number of SDFs included in the SDF group based on the group information and performs policy decisions for the SDFs corresponding to the number of SDFs.

In one implementation, the group information includes all SDF flow description information included in the SDF group. When the PCF receives the AF session request, the PCF determines all SDF flow description information included in the SDF group based on the group information, and after receiving the SDF corresponding to the corresponding SDF flow description information, the PCF performs a policy decision on the SDF.

In one implementation, the group information includes all SDF flow description information contained in the SDF group and the association relationship/priority relationship between respective SDFs.

When the PCF receives the AF session request, the PCF determines all SDF flow description information contained in the SDF group and the association relationship/priority relationship between respective SDFs based on the group information. The PCF can perform policy decisions for SDFs with stronger associations, or the PCF can prioritize the performing of policy decisions for SDFs with higher priorities.

In one implementation, the group information includes the number of terminals included in the SDF group and the number of SDFs corresponding to each terminal. When the PCF receives the AF session request, the PCF determines the number of terminals included in the SDF group and the number of SDFs corresponding to each terminal based on the group information, so that the PCF can determine whether the SDFs in the SDF group belong to the same terminal or multiple terminals, and make policy decisions.

In one implementation, the group information includes the number of terminals included in the SDF group and the SDF flow description information corresponding to each terminal. When the PCF receives the AF session request, the PCF determines the number of terminals included in the SDF group and the SDF flow description information corresponding to each terminal based on the group information, so that the PCF can determine whether the SDF in the SDF group belongs to the same terminal or multiple terminals and the SDF flow description information of each terminal, and make policy decisions.

In one implementation, the group information includes the number of terminals included in the SDF group, the SDF flow description information corresponding to each terminal, and the dependency relationship/priority relationship between respective SDFs. When the PCF receives the AF session request, the PCF determines the number of terminals included in the SDF group and the dependency relationship/priority relationship between respective SDFs in the SDF group based on the group information, so that the PCF can perform policy decisions for SDFs with stronger associations, or can preferentially perform policy decisions for SDFs with higher priorities.

In the disclosed embodiment, the PCF can determine through group information which SDFs belong to the same group, which UE the SDF corresponds to, and which SDFs of multiple UEs belong to the same group, thereby performing more reasonable policy decisions and resource authorizations for each SDF in the SDF group of the XRM service, and providing better QoS guarantee for the transmission of the SDF.

In the XRM service data transmission method provided by an embodiment of the present disclosure, the AF session request also includes a common identifier for identifying an SDF group, and the AF session request is used by the PCF entity to perform a policy decision on the AF session request based on the group information and the common identifier.

In the embodiment, multiple SDFs with a common identifier may correspond to the same terminal or multiple terminals.

In one implementation, when the SDFs indicated in the request information do not all belong to the same group, the group corresponding to each SDF is determined based on a common identifier of each SDF, and a policy decision is performed on the corresponding AF session request.

In the embodiment of the present disclosure, the PCF receives an AF session request. Since the AF session request includes the group information and session identifier of the SDF group, PCF can determine which SDFs are in one group based on the group information and session identifier of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, the policy decision includes:
authorizing the same QoS to each SDF in the SDF group; or
generating a respective Policy Control and Charging (PCC) rule for each SDF in the SDF group, and authorizing respective QoS to each SDF with.

In the embodiment, the PCC rules represent the service quality requirements and service billing requirements of the service. The network will provide different QoS services to users according to the service type and the user's subscription level, and report the billing information such as traffic and duration to the billing center for billing by detecting different service data flows.

In the embodiment of the present disclosure, after determining the SDF group to which the SDF belongs by the PCF based on the group information and/or the common identifier, policy decisions can be made for the SDFs in the same group, such as authorizing the same QoS or authorizing respective QoS to each SDF, so that the PCF can make more reasonable policy decisions and authorize resources for the XRM service, providing better QoS guarantee for the transmission of the SDF.

In the XRM service data transmission method provided by an embodiment of the present disclosure, an AF entity sends an AF session request to a PCF entity, or at least one functional entity of a NEF entity, and a TSCTSF entity.

In the embodiment, when the AF is a trusted AF, the AF entity can directly send the AF session request to the PCF entity. When the AF entity is an untrusted AF entity, the AF entity sends the AF session request to the PCF through the NEF entity and/or the TSCTSF entity.

In the XRM service data transmission method provided in an embodiment of the present disclosure, the AF may send an AF session request in the following process:
(a) Setting up an AF session with required QoS procedure;
(b) AF session with required QoS update procedure
(c) Service specific parameter provisioning process; and
(d) Set a policy for a future AF session.

Based on the same concept, an embodiment of the present disclosure also provides an XRM service data transmission method.

FIG. 7 is a flowchart of a method for transmitting XRM service data according to an exemplary embodiment. As shown in FIG. 7, the XRM service data transmission is performed by a core network element function and includes the following steps.

In step S61, an AF session request is received, where the AF session request includes group information of an SDF group.

In the embodiment, the group information of the SDF group is used to indicate the attribute information of the SDFs belonging to the same group, such as the number of SDFs belonging to the same group, the SDF flow description information, the number of corresponding terminals, etc.

In one implementation, the multiple SDFs indicated by the group information of the SDF group are from the same terminal or from different terminals (i.e., a terminal group).

In one implementation, the AF session request is used by the PCF entity to perform a policy decision on the AF session request.

In step S62, an AF session request is sent to the PCF entity.

In the embodiment of the present disclosure, the core network element function receives an AF session request sent by the AF and sends the AF session request to the PCF entity. Since the AF session request includes group information of the SDF group, the PCF entity can determine the group information of the SDF group and determine which SDFs form one group, such that the PCF performs more reasonable policy decisions and resource authorizations for each SDF in the SDF group, and providing better QoS guarantee for the transmission of the SDF.

In the XRM service data transmission method provided in an embodiment of the present disclosure, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the group information includes the number of SDFs included in the SDF group. When the PCF receives the AF session request, the PCF determines the number of SDFs included in the SDF group based on the group information and performs policy decisions for the SDFs corresponding to the number of SDFs.

In one implementation, the group information includes all SDF flow description information included in the SDF group. When the PCF receives the AF session request, the PCF determines all SDF flow description information included in the SDF group based on the group information, and after receiving the SDF corresponding to the corresponding SDF flow description information, the PCF performs a policy decision on the SDF.

In one implementation, the group information includes all SDF flow description information contained in the SDF group and the association relationship/priority relationship between respective SDFs.

When the PCF receives the AF session request, the PCF determines all SDF flow description information contained in the SDF group and the association relationship/priority relationship between respective SDFs based on the group information. The PCF can perform policy decisions for SDFs with stronger associations, or the PCF can prioritize the performing of policy decisions for SDFs with higher priorities.

In one implementation, the group information includes the number of terminals included in the SDF group and the number of SDFs corresponding to each terminal. When the PCF receives the AF session request, the PCF determines the number of terminals included in the SDF group and the number of SDFs corresponding to each terminal based on the group information, so that the PCF can determine whether the SDFs in the SDF group belong to the same terminal or multiple terminals, and make policy decisions.

In one implementation, the group information includes the number of terminals included in the SDF group and the SDF flow description information corresponding to each terminal. When the PCF receives the AF session request, the PCF determines the number of terminals included in the SDF group and the SDF flow description information corresponding to each terminal based on the group information, so that the PCF can determine whether the SDF in the SDF group belongs to the same terminal or multiple terminals and the SDF flow description information of each terminal, and make policy decisions.

In one implementation, the group information includes the number of terminals included in the SDF group, the SDF flow description information corresponding to each terminal, and the dependency relationship/priority relationship between respective SDFs. When the PCF receives the AF session request, the PCF determines the number of terminals included in the SDF group and the dependency relationship/priority relationship between respective SDFs in the SDF group based on the group information, so that the PCF can perform policy decisions for SDFs with stronger associations, or can preferentially perform policy decisions for SDFs with higher priorities.

In the disclosed embodiment, the PCF can determine through group information which SDFs belong to the same group, which UE the SDF corresponds to, and which SDFs of multiple UEs belong to the same group, thereby performing more reasonable policy decisions and resource authorizations for each SDF in the SDF group of the XRM service, and providing better QoS guarantee for the transmission of the SDF.

In the XRM service data transmission method provided by an embodiment of the present disclosure, the AF session request also includes a common identifier for identifying an SDF group, and the AF session request is used by the PCF entity to perform a policy decision on the AF session request based on the group information and the common identifier.

In the embodiment, multiple SDFs with a common identifier may correspond to the same terminal or multiple terminals.

In one implementation, when the SDFs indicated in the request information do not all belong to the same group, the group corresponding to each SDF is determined based on a common identifier of each SDF, and a policy decision is performed on the corresponding AF session request.

In the embodiment of the present disclosure, the PCF receives an AF session request. Since the AF session request includes the group information and session identifier of the SDF group, PCF can determine which SDFs are in one group based on the group information and session identifier of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, the policy decision includes:
authorizing the same QoS to each SDF in the SDF group; or
generating a respective Policy Control and Charging (PCC) rule for each SDF in the SDF group, and authorizing respective QoS to each SDF with.

In the embodiment, the PCC rules represent the service quality requirements and service billing requirements of the service. The network will provide different QoS services to users according to the service type and the user's subscription level, and report the billing information such as traffic and duration to the billing center for billing by detecting different service data flows.

In the embodiment of the present disclosure, after determining the SDF group to which the SDF belongs by the PCF based on the group information and/or the common identifier, policy decisions can be made for the SDFs in the same group, such as authorizing the same QoS or authorizing respective QoS to each SDF, so that the PCF can make more reasonable policy decisions and authorize resources for the XRM service, providing better QoS guarantee for the transmission of the SDF.

In the XRM service data transmission method provided by an embodiment of the present disclosure, an AF entity sends an AF session request to a PCF entity, or at least one functional entity of a NEF entity, and a TSCTSF entity.

In the embodiment, when the AF is a trusted AF, the AF entity can directly send the AF session request to the PCF entity. When the AF entity is an untrusted AF entity, the AF entity sends the AF session request to the PCF through the NEF entity and/or the TSCTSF entity.

In the XRM service data transmission method provided in an embodiment of the present disclosure, the AF may send an AF session request in the following process:
(a) Setting up an AF session with required QoS procedure;
(b) AF session with required QoS update procedure
(c) Service specific parameter provisioning process; and
(d) Set a policy for a future AF session.

Hereinafter, the XRM service data transmission method proposed in an embodiment of the present disclosure is described from the perspective of the interaction process between various entities.

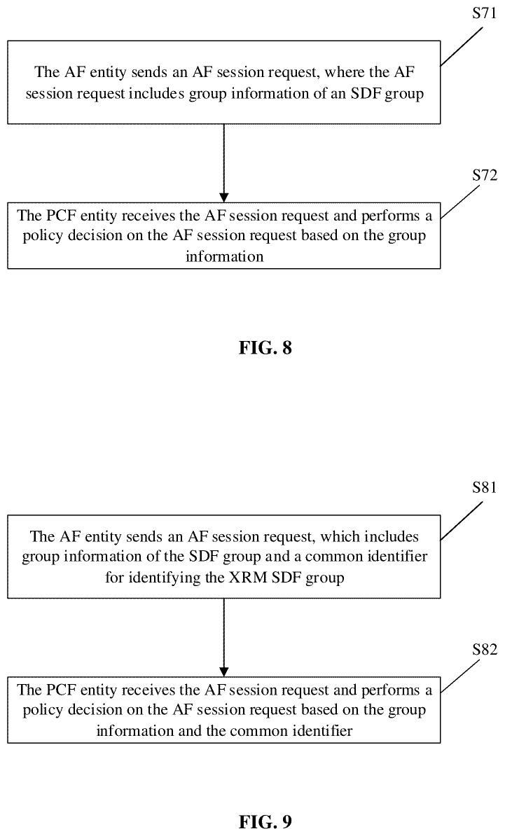

FIG. 8 is a flow chart of a method for XRM service data transmission according to an exemplary embodiment. As shown in FIG. 8, the method includes the following steps.

In step S71, the AF entity sends an AF session request, where the AF session request includes group information of an SDF group.

In the embodiment, the SDF group is used to indicate the attribute information of the SDFs belonging to the same group, such as the number of SDFs belonging to the same group, SDF flow description information, the number of corresponding terminals, etc.

In one implementation, the multiple SDFs indicated by the group information of the SDF group are from the same terminal or from different terminals (i.e., a terminal group).

In step S72, the PCF entity receives the AF session request and performs a policy decision on the AF session request based on the group information.

In the embodiment of the present disclosure, the PCF entity receives an AF session request. Since the AF session request includes group information of the SDF group, the PCF entity can determine which SDFs form one group based on the group information of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the group information includes the number of SDFs included in the SDF group. When the PCF entity receives the AF session request, the PCF determines the number of SDFs included in the SDF group based on the group information and performs policy decisions for the SDFs corresponding to the number of SDFs.

In one implementation, the group information includes all SDF flow description information included in the SDF group. When the PCF entity receives the AF session request, the PCF determines all SDF flow description information included in the SDF group based on the group information, and after receiving the SDF corresponding to the corresponding SDF flow description information, the PCF performs a policy decision on the SDF.

In one implementation, the group information includes all SDF flow description information contained in the SDF group and the association relationship/priority relationship between respective SDFs.

When the PCF entity receives the AF session request, the PCF determines all SDF flow description information contained in the SDF group and the association relationship/priority relationship between respective SDFs based on the group information. The PCF can perform policy decisions for SDFs with stronger associations, or the PCF can prioritize the performing of policy decisions for SDFs with higher priorities.

In one implementation, the group information includes the number of terminals included in the SDF group and the number of SDFs corresponding to each terminal. When the PCF entity receives the AF session request, the PCF determines the number of terminals included in the SDF group and the number of SDFs corresponding to each terminal based on the group information, so that the PCF entity can determine whether the SDFs in the SDF group belong to the same terminal or multiple terminals, and make policy decisions.

In one implementation, the group information includes the number of terminals included in the SDF group and the SDF flow description information corresponding to each terminal. When the PCF entity receives the AF session request, the PCF determines the number of terminals included in the SDF group and the SDF flow description information corresponding to each terminal based on the group information, so that the PCF entity can determine whether the SDF in the SDF group belongs to the same terminal or multiple terminals and the SDF flow description information of each terminal, and make policy decisions.

In one implementation, the group information includes the number of terminals included in the SDF group, the SDF flow description information corresponding to each terminal, and the dependency relationship/priority relationship between respective SDFs. When the PCF entity receives the AF session request, the PCF determines the number of terminals included in the SDF group and the dependency relationship/priority relationship between respective SDFs in the SDF group based on the group information, so that the PCF entity can perform policy decisions for SDFs with stronger associations, or can preferentially perform policy decisions for SDFs with higher priorities.

In the disclosed embodiment, the PCF entity can determine through group information which SDFs belong to the same group, which UE the SDF corresponds to, and which SDFs of multiple UEs belong to the same group, thereby performing more reasonable policy decisions and resource authorizations for each SDF in the SDF group of the XRM service, and providing better QoS guarantee for the transmission of the SDF.

In the XRM service data transmission method provided by an embodiment of the present disclosure, the AF session request also includes a common identifier for identifying an SDF group. When the SDFs indicated in the request information do not all belong to the same group, the group corresponding to each SDF is determined based on the common identifier of each SDF, and a policy decision is performed on the corresponding AF session request. Based on this, an embodiment of the present disclosure also provides an XRM service data transmission method, as shown in FIG. 9, comprising the following steps:

In step S81, the AF entity sends an AF session request, which includes group information of the SDF group and a common identifier for identifying the XRM SDF group.

In step S82, the PCF entity receives the AF session request and performs a policy decision on the AF session request based on the group information and the common identifier.

In one implementation, the SDF group information requested by the AF indicates 10 SDFs, while the 10 SDFs do not belong to the same group. When receiving the AF session request corresponding to the 10 SDFs, the SDF group to which they belong is determined based on their respective common identifiers.

In the embodiment, multiple SDFs with a common identifier may correspond to the same terminal or multiple terminals.

In the embodiment of the present disclosure, the PCF entity is able to receive an AF session request. Since the AF session request includes the group information and session identifier of the SDF group, PCF entity can determine which SDFs are in one group based on the group information and session identifier of the SDF group, thereby performing more reasonable policy decisions and resource authorizations for each SDF in the SDF group, and providing better QoS guarantee for the transmission of the SDF.

In the XRM service data transmission method provided in an embodiment of the present disclosure, performing the policy decision on the AF session request includes:
the PCF entity authorizes the same QoS to each SDF in the SDF group; or
the PCF entity generates a respective Policy Control and Charging (PCC) rule for each SDF in the SDF group, and authorizes respective QoS to each SDF with.

In the embodiment, the PCC rules represent the service quality requirements and service billing requirements of the service. The network will provide different QoS services to users according to the service type and the user's subscription level, and report the billing information such as traffic and duration to the billing center for billing by detecting different service data flows.

In the embodiment of the present disclosure, after determining the SDF group to which the SDF belongs, policy decisions can be made for the SDFs in the same group, such as authorizing the same QoS or authorizing respective QoS to each SDF, so that the core network device can make more reasonable policy decisions and authorize resources for the XRM service, providing better QoS guarantee for the transmission of the SDF.

In the XRM service data transmission method provided in an embodiment of the present disclosure, the PCF entity may perform the XRM service data transmission method provided in the embodiment of the present disclosure in the following process:
(a) Setting up an AF session with required QoS procedure;
(b) AF session with required QoS update procedure
(c) Service specific parameter provisioning process; and
(d) Set a policy for a future AF session.

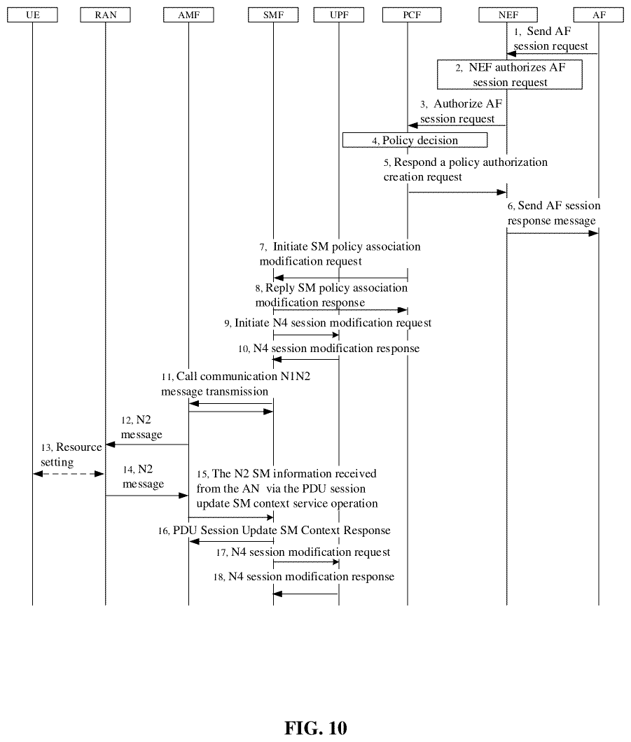

Hereinafter, taking process (a): Setting up an AF session with required QoS procedure as an example, the XRM service data transmission method provided by the embodiment of the present disclosure is described fully and in detail, as shown in FIG. 10.
1. The AF sends an AF session request, for example, by creating an AF session request through an AF session with a QoS creation request, where the AF session request includes group information of the SDF group.

In one implementation, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation, the AF session request may further include a common identifier for identifying an XRM service SDF group, and SDFs with the common identifier having the same value belong to the same XRM service.

In one implementation, the AF session request may also include information such as a UE address or UE identifier, an AF identifier, an application identifier, a DNN, S-NSSAI, and QoS parameters.

2. The NEF authorizes the AF session request. If the AF is an untrusted AF, the AF sends the AF session request to the PCF through the NEF. In one implementation, the NEF performs relevant mapping, including mapping of XRM service (AF service identifier) to DNN and S-NSSAI, mapping of external application to core network (CN) application identifier; and mapping of external UE identifier to UE identifier within CN (such as Subscriber Permanent Identifier (SUPI)) based on the UDM subscription information, and mapping of external to internal XRM service group identifier according to UDM subscription information.
3. The NEF authorizes the AF session request and determines whether to call the TSCTSF or contact the PCF directly based on the parameters provided by the AF. These signaling steps are the same as the steps for setting up an AF session with the required QoS program in TS 23.502 Section 4.15.6.6. The PCF receives the AF session request sent by the AF from the NEF or the TSCTSF. The NEF triggers a policy authorization create request (Npcf_Policy Authorization_Create request) and sends the AF session request to the PCF for the PCF to make policy decisions on the AF session.
4. The PCF makes policy decisions. The PCF may determine updated or new policy decision information that needs to be sent to the SMF.

In one implementation, the PCF performs a policy decision on the AF session request based on the group information of the SDF group.

In one implementation, the PCF performs a policy decision on the AF session request based on the group information of the SDF group and the common identifier.

The policy decision includes: authorizing the same QoS file for each SDF in the SDF group; or generating a respective PCC rule for each SDF in the SDF group, and authorizing a respective QoS for each SDF.
5. The PCF responds to the NEF with a policy authorization creation request.
6. The NEF sends an AF session response message to the AF. The AF session response message carries the authorization result, which is used to inform the AF whether the AF session request is authorized.
7. The PCF initiates an SM policy association modification request (PCC rule (QoS monitoring policy)) to the SMF.

Based on the QoS policy decision from the PCF, the SMF generates the QoS monitoring configuration for the UPF (and for the RAN) as described in step 4.
8. The SMF replies to the PCF with an SM policy association modification response.
9. The SMF initiates an N4 session modification request (QoS monitoring configuration) to the UPF.
10. After receiving the QoS monitoring configuration, the UPF enables measurement and reporting. The UPF responds to the SMF.
11. For the modification requested by the SMF, the SMF calls the communication NIN2 message transmission ([N2 SM information] (PDU session ID, QFI, QoS profile, QoS monitoring configuration), N1 SM container).
12. The AMF may send N2 (SM information received by N2 from SMF), NAS message (PDU Session ID, N1 SM container (PDU Session Modification Command)) message to the (R)AN. After receiving the QoS monitoring configuration, the RAN enables event measurement and reporting.
13. The UE and the RAN perform resource settings.
14. The (R)AN may confirm the N2 PDU session request by sending an N2 PDU session confirm message to the AMF.
15. The AMF forwards the N2 SM information received from the AN to the SMF via the PDU session update SM context service operation.
16. The SMF replies with PDU Session Update SM Context Response.
17-18. The SMF can update the N4 session of the UPF involved in the PDU session modification by sending an N4 session modification request message to the UPF. When the PCF receives the QoS monitoring report, the PCF sends a notification to the AF.

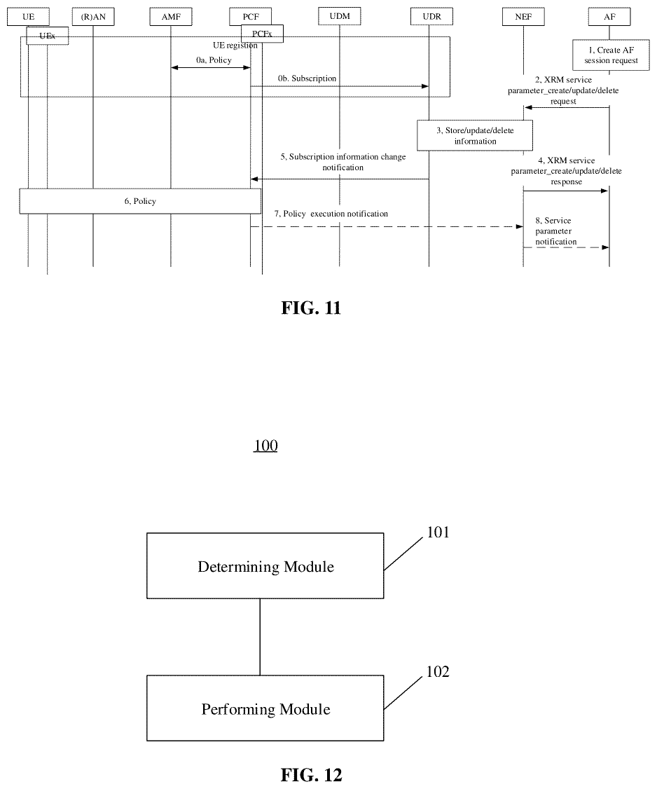

Hereinafter, taking process (b): Service specific parameter provisioning procedure as an example, the XRM service data transmission method provided by the embodiment of the present disclosure is described fully and in detail, as shown in FIG. 11.
0. Some or all UEs related to XRM services or multi-mode data services have registered with the network and selected the PCF to complete AM session association. The PCF subscribes to the UDM for change notifications of subscription information related to XRM services or multi-mode data services based on the policy and QoS requirements of the XRM service.
1. The AF triggers the XRM service parameter service and creates an AF session request, where the AF session request includes the group information of the SDF group.

In one implementation, the group information includes at least one of the following:
the number of SDFs contained in the SDF group;
all SDF flow description information contained in the SDF group;
all SDF flow description information contained in the SDF group and the association relationship/priority relationship between respective SDFs;
the number of terminals included in the SDF group and the number of SDFs corresponding to each terminal;
the number of terminals included in the SDF group and the SDF flow description information corresponding to each terminal; and
the number of terminals contained in the SDF group, the SDF flow description information corresponding to each terminal, and the dependency relationship/priority relationship between respective SDFs.

In one implementation manner, the AF session request may further include a common identifier for identifying an XRM service SDF group, and the SDFs with the common identifier having the same value belong to the same XRM service.

In one implementation, the AF session request may also include information such as a UE address or UE identifier, an AF identifier, an application identifier, a DNN, S-NSSAI, and QoS parameters.

The AF provides XRM service or multiple data service specific parameters to one or more UEs related to the service through XRM service parameter service. The AF session request includes: service description, common identification, service parameters, UE or UE group, subscription to events and other information.

In the embodiment, the service description (Service Description) identifies the XRM service or XRM data service, which can be identified by a DNN and S-NSSAI group, or XRM ID; or represented by an AF service identifier (Service-Identifier) or an external application identifier (Application Identifier).

Service Parameters: Information about the AF guidelines for policy and QoS determination related to XRM services or multi-mode data services. List of rules for associating XRM services or multiple data service application traffic, parameters such as UE policy, common identification or group identification, DNN and S-NSSAI groups, SSC mode, and selection priority of corresponding rules (e.g., priority of alternative QoS parameters, priority of time threshold, priority of access type or route selection, and so on).

UE or UE group: A single UE, or multiple UEs (Group UE) related to the XRM service or multimode data service associated with the AF request.

Subscription to events: The AF can subscribe to notifications about SM policy results or the execution and change of AM policy or UE policy. Or, event subscription for XRM service data flow.

When the AF needs to update or delete the corresponding request or subscription, the update or deletion process of the AF session request can also be initiated through this service.
2. The AF sends the request to the NEF. The NEF authorizes the AF's request. The NEF performs relevant mappings, including mapping of XRM service or XRM data service (AF service identifier) to DNN and S-NSSAI, mapping of external application to CN application identifier; and mapping of external UE identifier to CN internal UE identifier (such as SUPI) based on UDM subscription information, as well as mapping of external to internal XRM service group identifiers according to UDM subscription information.
3. The NEF stores the requested information in the UDR (e.g., as service feature parameter information storage of application data). In one implementation, the NEF may improve the corresponding service parameters according to the local configuration.

In one implementation, the NEF may combine the operator's policy and subscription information to confirm whether the requested service feature is authorizable for an XRM service or a multi-mode data service for a single UE or a UE group and store the corresponding parameters in the UDR.

If multiple UEs are involved, the NEF transmits the relevant service parameters to the PCF, and performs the corresponding authorization in each PCF, as well as the decision or update of policies and rules. The PCF stores the corresponding information in the UDR based on the authorization result of the request. (Supports single PCF and multi-PCF scenarios)

In multi-UE scenarios, the subscription data of UE group members can be associated through XRM service indication or Group ID/Common ID.

The AF or the PCF can subscribe to relevant XRM services or multi-mode data related event triggers through the NEF, such as QoS monitoring report, service QoS update, UE relocation, PCF change, etc. The AF or the PCF receives the NEF report, obtains corresponding notification, and executes subsequent application requirements or QoS rule updates.
4. The NEF returns a create request response message to the AF.

If in step 0, the PCF executes the subscription information update notification after the UE is registered, the subsequent process is executed because the AF requests to update the UDR subscription information.
5. The PCF receives notification of subscription information change from the UDR.
6. The PCF transmits the UE policy to the UE.
7. If the AF subscribes to the execution notification of the relevant policies of the XRM service, the PCF sends the relevant execution results to the AF through the NEF. At the same time, if there is a change in the relevant subscription parameters, the PCF updates the change to the UDR, triggering the serving PCF execution policy change and collaboration of other UEs related to the XRM service group.
8. After receiving the notification, the NEF first performs the mapping of relevant internal and external parameters, and then sends the relevant report to the AF.

In the embodiment of the present disclosure, the PCF receives an AF session request. Since the AF session request includes group information of the SDF group, the PCF can determine which SDFs form one group based on the group information of the SDF group, thereby performing more reasonable policy decisions and resource authorizations for each SDF in the SDF group, and providing better QoS guarantee for the transmission of the SDF.

It should be noted that those skilled in the art can understand that the various implementation methods/embodiments involved in the embodiments of the present disclosure can be used in conjunction with the aforementioned embodiments or can be used independently. The implementation principle is similar regardless of being used alone or in conjunction with the aforementioned embodiments. In the implementation of the present disclosure, some embodiments are described in terms of implementation methods used together. Of course, those skilled in the art can understand that such examples are not limitations of the embodiments of the present disclosure.

Based on the same concept, the embodiment of the present disclosure also provides an apparatus for extended reality and multimedia service data transmission.

It is understandable that the apparatus for extended reality and multimedia service data transmission provided by the embodiment of the present disclosure includes hardware structures and/or software modules corresponding to the execution of each function in order to realize the above functions. In combination with the units and algorithm steps of each example disclosed in the embodiment of the present disclosure, the embodiment of the present disclosure can be implemented in the form of hardware or a combination of hardware and computer software. Whether a function is executed in the form of hardware or computer software driving hardware depends on the specific application and design constraints of the technical solution. Those skilled in the art can use different methods to implement the described functions for each specific application, but such implementation should not be considered to exceed the scope of the technical solution of the embodiment of the present disclosure.

FIG. 12 is a block diagram of an apparatus for extended reality and multimedia service data transmission according to an exemplary embodiment. Referring to FIG. 12, the apparatus 100 includes a determining module 101 and a performing module 102.

The determining module 101 is configured to determine an AF session request, where the AF session request includes group information of an SDF group; and

The performing module 102 is configured to perform a policy decision on the AF session request based on the group information.

In one implementation, the group information includes at least one of:
a quantity of SDFs included in the SDF group;
all SDF flow description information included in the SDF group;
all SDF flow description information included in the SDF group and an association relationship/priority relationship between respective SDFs;
a quantity of terminals included in the SDF group and the quantity of SDFs corresponding to each terminal;
a quantity of terminals included in the SDF group and SDF flow description information corresponding to each terminal; or
a quantity of terminals included in the SDF group and SDF flow description information corresponding to each terminal and a dependency relationship/priority relationship between respective SDFs.

In one implementation, the AF session request further includes a common identifier for identifying the SDF group; and the performing module 102 is configured to perform the policy decision on the AF session request based on the group information and the common identifier.

In one implementation, the performing module 102 is configured to authorize a same quality of service (QoS) profile to each SDF in the SDF group; or
generate a respective PCC rule for each SDF in the SDF group, and authorize a respective QoS for each SDF.

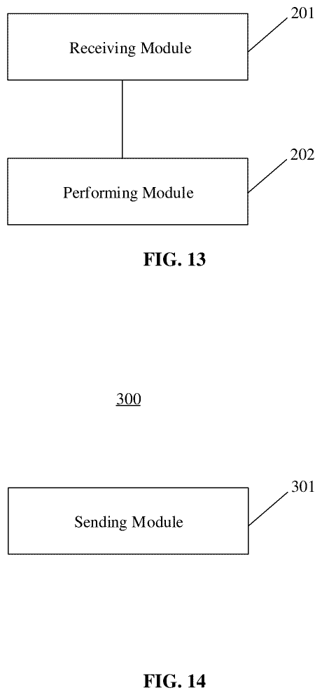

FIG. 13 is a block diagram of an apparatus for extended reality and multimedia service data transmission according to an exemplary embodiment. Referring to FIG. 13, the apparatus 200 includes a receiving module 201 and a performing module 202.

The receiving module 201 is configured to receive an application function (AF) session request, where the AF session request includes group information of a service data flow (SDF) group; and The performing module 202 is configured to perform a policy decision on the AF session request based on the group information.

In one implementation, the group information includes at least one of:
a quantity of SDFs included in the SDF group;
all SDF flow description information included in the SDF group;
all SDF flow description information included in the SDF group and an association relationship/priority relationship between respective SDFs;
a quantity of terminals included in the SDF group and the quantity of SDFs corresponding to each terminal;
a quantity of terminals included in the SDF group and SDF flow description information corresponding to each terminal; or
a quantity of terminals included in the SDF group and SDF flow description information corresponding to each terminal and a dependency relationship/priority relationship between respective SDFs.

In one implementation, the AF session request further includes a common identifier for identifying the SDF group; and
the performing module 202 is configured to perform the policy decision on the AF session request based on the group information and the common identifier.

In one implementation, the performing module 202 is configured to authorize a same quality of service (QOS) profile to each SDF in the SDF group; or
generate a respective PCC rule for each SDF in the SDF group, and authorize a respective QoS for each SDF.

In one implementation, the receiving module 201 is configured to receive the AF session request sent by an AF entity, or at least one of a network exposure function (NEF) entity and a time sensitive communication and time synchronization function (TSCTSF) entity.

FIG. 14 is a block diagram of an apparatus for extended reality and multimedia service data transmission according to an exemplary embodiment. Referring to FIG. 14, the apparatus 300 includes a sending module 301. The sending module 301 is configured to send an application function (AF) session request, where the AF session request includes group information of a service data flow (SDF) group, and the AF session request is used by a policy control function (PCF) entity to perform a policy decision on the AF session request.

The group information includes at least one of:
a quantity of SDFs included in the SDF group;
all SDF flow description information included in the SDF group;
all SDF flow description information included in the SDF group and an association relationship/priority relationship between respective SDFs;
a quantity of terminals included in the SDF group and the quantity of SDFs corresponding to each terminal;
a quantity of terminals included in the SDF group and SDF flow description information corresponding to each terminal; or
a quantity of terminals included in the SDF group and SDF flow description information corresponding to each terminal and a dependency relationship/priority relationship between respective SDFs.

In one implementation, the AF session request further includes a common identifier for identifying the SDF group; and
the AF session request is used by the PCF entity to perform the policy decision on the AF session request based on the group information and the common identifier.

In one implementation, the policy decision includes:
authorizing a same quality of service (QoS) profile to each SDF in the SDF group; or
generating a respective PCC rule for each SDF in the SDF group, and authorizing a respective QoS for each SDF.

In one implementation, the sending module is configured to send the AF session request to the PCF entity, or at least one of a network exposure function (NEF) entity and a time sensitive communication and time synchronization function (TSCTSF) entity.

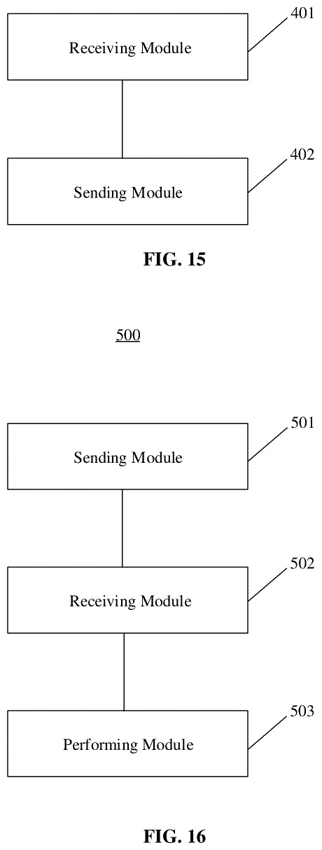

FIG. 15 is a block diagram of an apparatus for extended reality and multimedia service data transmission according to an exemplary embodiment. Referring to FIG. 15, the apparatus 400 includes a receiving module 401 and a sending module 402.
the receiving module 401 is configured to receive an application function (AF) session request, where the AF session request includes group information of a service data flow (SDF) group, and the AF session request is used by a policy control function (PCF) entity to perform a policy decision on the AF session request; and
the sending module 402 is configured to send the AF session request to the policy control function (PCF) entity.

In one implementation, the group information includes at least one of:
a quantity of SDFs included in the SDF group;
all SDF flow description information included in the SDF group;
all SDF flow description information included in the SDF group and an association relationship/priority relationship between respective SDFs;
a quantity of terminals included in the SDF group and the quantity of SDFs corresponding to each terminal;
a quantity of terminals included in the SDF group and SDF flow description information corresponding to each terminal; or
a quantity of terminals included in the SDF group and SDF flow description information corresponding to each terminal and a dependency relationship/priority relationship between respective SDFs.

In one implementation, the AF session request further includes a common identifier for identifying the SDF group; and
the AF session request is used by the PCF entity to perform the policy decision on the AF session request based on the group information and the common identifier.

In one implementation, the policy decision includes:
authorizing a same quality of service (QoS) profile to each SDF in the SDF group; or
generating a respective PCC rule for each SDF in the SDF group, and authorizing a respective QoS for each SDF.

In one implementation, the core network element function includes a network exposure function (NEF) entity and/or a time sensitive communication and time synchronization function (TSCTSF) entity.

FIG. 16 is a block diagram of an apparatus for extended reality and multimedia service data transmission according to an exemplary embodiment. Referring to FIG. 16, the apparatus 500 includes a sending module 501, a receiving module 502 and performing module 503.
in the sending module 501, an application function (AF) entity sends an application function (AF) session request, where the AF session request includes group information of a service data flow (SDF) group; and
the receiving module 502 is configured to receive by a policy control function (PCF) entity, the AF session request, and
the performing module 503 is configured to perform, by the PCF entity, a policy decision on the AF session request based on the group information.

In one implementation, the group information includes at least one of:
a quantity of SDFs included in the SDF group;
all SDF flow description information included in the SDF group;
all SDF flow description information included in the SDF group and an association relationship/priority relationship between respective SDFs;
a quantity of terminals included in the SDF group and the quantity of SDFs corresponding to each terminal;
a quantity of terminals included in the SDF group and SDF flow description information corresponding to each terminal; or
a quantity of terminals included in the SDF group and SDF flow description information corresponding to each terminal and a dependency relationship/priority relationship between respective SDFs.

In one implementation, the AF session request further includes a common identifier for identifying the SDF group; and
the performing module 503 is configured to perform, by the PCF entity, the policy decision on the AF session request based on the group information and the common identifier.

In one implementation, the performing module 503 is configured to authorize a same quality of service (QoS) profile to each SDF in the SDF group; or
generate a respective PCC rule for each SDF in the SDF group, and authorize a respective QoS for each SDF.

In one implementation, the sending module 501 is configured to send, by the AF entity, the AF session request to at least one of a network exposure function (NEF) entity, a time sensitive communication and time synchronization function (TSCTSF) entity, and the PCF entity.

In one implementation, the receiving module 502 is configured to receive, by the PCF entity, the AF session request sent by the AF entity, or at least one of a network exposure function (NEF) entity and a time sensitive communication and time synchronization function (TSCTSF) entity.

Regarding the apparatus in the above embodiment, the specific manner in which each module performs operations has been described in detail in the embodiment of the method, and will not be elaborated here.

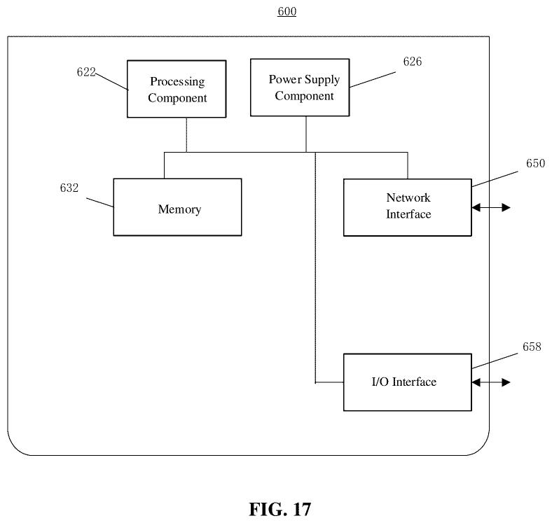

FIG. 17 is a block diagram of an apparatus 600 for an extended reality and multimedia service data transmission according to an exemplary embodiment. For example, the apparatus 600 may be provided as a server. Referring to FIG. 17, the apparatus 600 includes a processing component 622, which further includes one or more processors, and a memory resource represented by a memory 632 for storing instructions executable by the processing component 622, such as an application. The application stored in the memory 632 may include one or more modules, each corresponding to a set of instructions. In addition, the processing component 622 is configured to execute instructions to perform the above method.

The apparatus 600 may also include a power supply component 626 configured to perform power management of the apparatus 600, a wired or wireless network interface 650 configured to connect the apparatus 600 to a network, and an input/output (I/O) interface 658. The apparatus 600 may operate based on an operating system stored in the memory 632, such as Windows Server™, Mac OS X™, Unix™, Linux™, FreeBSD™, or the like.

In an exemplary embodiment, a non-transitory computer-readable storage medium including instructions is also provided, such as a memory 632 including instructions, and the instructions can be executed by the Processing Component 622 of the apparatus 600 to perform the above method. For example, the non-transitory computer-readable storage medium can be a ROM, a random access memory (RAM), a CD-ROM, a magnetic tape, a floppy disk, an optical data storage device, etc.

It is further understood that in the present disclosure, “multiple” refers to two or more than two, and other quantifiers are similar. “And/or” describes the association relationship of associated objects, indicating that three relationships may exist. For example, A and/or B can represent: A exists alone, A and B exist at the same time, and B exists alone. The character “/” generally indicates that the associated objects before and after are in an “or” relationship. The singular forms “a”, “the” and “the” are also intended to include the plural forms, unless the context clearly indicates other meanings.

It is further understood that the meanings of the words “in response to” and “if” involved in the present disclosure depend on the context and the actual usage scenario. For example, the word “in response to” used herein can be interpreted as “at . . . ” or “when . . . ” or “if” or “in case of”.

It is further understood that the terms “first”, “second”, etc. are used to describe various information, but such information should not be limited to these terms. These terms are only used to distinguish the same type of information from each other, and do not indicate a specific order or degree of importance. In fact, the expressions “first”, “second”, etc. can be used interchangeably. For example, without departing from the scope of the present disclosure, the first information can also be referred to as the second information, and similarly, the second information can also be referred to as the first information.

It can be further understood that, although the operations are described in a specific order in the drawings in the embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

Those skilled in the art will readily appreciate other embodiments of the present disclosure after considering the specification and practicing the invention disclosed herein. This application is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the precise structures that have been described above and shown in the drawings, and that various modifications and changes may be made without departing from the scope thereof. The scope of the present disclosure is limited only by the scope of the appended claims.

1. A method for extended reality and multimedia (XRM) services data transmission, applied in a core network device, and the method comprising:
determining an application function (AF) session request, wherein the AF session request comprises group information of a service data flow (SDF) group; and
performing a policy decision on the AF session request based on the group information.

2. The method according to claim 1, wherein the group information comprises at least one of:
a quantity of SDFs comprised in the SDF group;
all SDF flow description information comprised in the SDF group;
all SDF flow description information comprised in the SDF group and an association relationship/priority relationship between respective SDFs;
a quantity of terminals comprised in the SDF group and the quantity of SDFs corresponding to each terminal;
a quantity of terminals comprised in the SDF group and SDF flow description information corresponding to each terminal; or
a quantity of terminals comprised in the SDF group and SDF flow description information corresponding to each terminal and a dependency relationship/priority relationship between respective SDFs.

3. The method according to claim 1, wherein the AF session request further comprises a common identifier for identifying the SDF group; and
wherein performing the policy decision on the AF session request based on the group information comprises:
performing the policy decision on the AF session request based on the group information and the common identifier.

4. The method according to claim 3, wherein performing the policy decision on the AF session request comprises:
authorizing a same quality of service (QoS) profile to each SDF in the SDF group; or
generating a respective policy control and charging (PCC) rule for each SDF in the SDF group, and authorizing a respective QoS for each SDF.

5. A method for extended reality and multimedia (XRM) services data transmission, executed by a policy control function (PCF) entity in a core network device, and the method comprising:
receiving an application function (AF) session request, wherein the AF session request comprises group information of a service data flow (SDF) group; and
performing a policy decision on the AF session request based on the group information.

6. The method according to claim 5, wherein the group information comprises at least one of:
a quantity of SDFs comprised in the SDF group;
all SDF flow description information comprised in the SDF group;
all SDF flow description information comprised in the SDF group and an association relationship/priority relationship between respective SDFs;
a quantity of terminals comprised in the SDF group and the quantity of SDFs corresponding to each terminal;
a quantity of terminals comprised in the SDF group and SDF flow description information corresponding to each terminal; or
a quantity of terminals comprised in the SDF group and SDF flow description information corresponding to each terminal and a dependency relationship/priority relationship between respective SDFs.

7. The method according to claim 5, wherein the AF session request further comprises a common identifier for identifying the SDF group; and
wherein performing the policy decision on the AF session request based on the group information comprises:
performing the policy decision on the AF session request based on the group information and the common identifier.

8. The method according to claim 7, wherein performing the policy decision on the AF session request comprises:
authorizing a same quality of service (QoS) profile to each SDF in the SDF group; or
generating a respective policy control and charging (PCC) rule for each SDF in the SDF group, and authorizing a respective QoS for each SDF.

9. The method according to claim 5, wherein receiving the application function (AF) session request comprises:
receiving the AF session request sent by an AF entity, or at least one of a network exposure function (NEF) entity or a time sensitive communication and time synchronization function (TSCTSF) entity.

10. A method for extended reality and multimedia (XRM) services data transmission, executed by an application function (AF) entity, and the method comprising:
sending an application function (AF) session request, wherein the AF session request comprises group information of a service data flow (SDF) group, and the AF session request is used by a policy control function (PCF) entity to perform a policy decision on the AF session request.

11. The method according to claim 10, wherein the group information comprises at least one of:
a quantity of SDFs comprised in the SDF group;
all SDF flow description information comprised in the SDF group;
all SDF flow description information comprised in the SDF group and an association relationship/priority relationship between respective SDFs;
a quantity of terminals comprised in the SDF group and the quantity of SDFs corresponding to each terminal;
a quantity of terminals comprised in the SDF group and SDF flow description information corresponding to each terminal; or
a quantity of terminals comprised in the SDF group and SDF flow description information corresponding to each terminal and a dependency relationship/priority relationship between respective SDFs.

12. The method according to claim 10, wherein the AF session request further comprises a common identifier for identifying the SDF group; and
the AF session request is used by the PCF entity to perform the policy decision on the AF session request based on the group information and the common identifier.

13. The method according to claim 12, wherein the policy decision comprises:
authorizing a same quality of service (QoS) profile to each SDF in the SDF group; or
generating a respective policy control and charging (PCC) rule for each SDF in the SDF group, and authorizing a respective QoS for each SDF.

14. The method according to claim 10, wherein sending the application function (AF) session request comprises:
sending the AF session request to the PCF entity, or at least one of a network exposure function (NEF) entity or a time sensitive communication and time synchronization function (TSCTSF) entity.

15. The method according to claim 1, wherein determining the AF session request comprises:
receiving, by a core network element function, the AF session request, wherein the AF session request is used by a policy control function (PCF) entity to perform a policy decision on the AF session request; and
sending, by the core network element function, the AF session request to the policy control function (PCF) entity.

16. (canceled)

17. The method according to claim 15, wherein the AF session request further comprises a common identifier for identifying the SDF group; and
the AF session request is used by the PCF entity to perform the policy decision on the AF session request based on the group information and the common identifier.

18. (canceled)

19. The method according to claim 15, wherein the core network element function comprises at least one of a network exposure function (NEF) entity or a time sensitive communication and time synchronization function (TSCTSF) entity.

20.-25. (canceled)

26. An apparatus for extended reality and multimedia (XRM) services data transmission, wherein the apparatus comprises:
a processor; and
a memory storing instructions executable by the processor;
wherein the processor is configured to perform the method according to claim 1.

27. An apparatus for extended reality and multimedia (XRM) services data transmission, wherein the apparatus comprises:
a processor; and
a memory storing instructions executable by the processor;
wherein the processor is configured to perform the method according to claim 5.

28. An apparatus for extended reality and multimedia (XRM) services data transmission, wherein the apparatus comprises:
a processor; and
a memory storing instructions executable by the processor;
wherein the processor is configured to perform the method according to claim 10.

29.-34. (canceled)
